(19) United States
(12) Patent Application Publication
(10) Pub. No.: US 2008/0248262 A1
(43) Pub. Date: Oct. 9, 2008

(54) Press-on fragrance product applicator

(76) Inventor: Irina Iosilevich, Boca Raton, FL (US)

Correspondence Address: FRANK L. KUBLER, 13261 S.W. 54th Court, Miramar, FL, 33027, US

(21) Appl. No.: 12/004,808

(22) Filed: Dec. 21, 2007

Related U.S. Application Data
(60) Provisional application No. 60/876,893, filed on Dec. 22, 2006.

(51) Int. Cl. B32B 5/00

(52) U.S. Cl. 428/195.1

(57) ABSTRACT

A press-on applicator for applying cosmetic colors to arms or other regions of a customer body leaves indicia identifying a product brand and leaves fragrance material producing a fragrance corresponding to the identified brand, so that after sufficient time has passed for the fragrance to mix and react with customer body chemistry and produce a final scent of fragrance, the customer can identify which brand of fragrance product was applied and thus to determine whether he or she wishes to purchase the brand. This applicator applies pigment material directly to bare customer skin.

### FILING HISTORY

This application continues from provisional patent application Ser. No. 60/876,893, filed on Dec. 22, 2006.

### BACKGROUND OF THE INVENTION

1. Field of the Invention

The present invention relates generally to the field of cosmetics application devices and methods. More specifically, the present invention relates to a press-on applicator for applying cosmetic colors to arms or other regions of a customer body to leave indicia identifying a product brand and to simultaneously applying fragrance corresponding to the identified brand, so that after sufficient time has passed for the fragrance to mix and react with customer body chemistry and produce a final fragrance, the customer can still identify which brand of fragrance product was applied and thus determine whether he or she wishes to purchase the brand. This applicator applies color mixed with fragrance directly to bare customer skin. The indicia may be a printed brand name only or brand logo, but more preferably is an image of the brand bottle itself including its identifying label.

Each press-on applicator includes a soft color carrier sheet, impregnated with a pre-measured amount of cosmetic indicia material fortified with vitamins, moisturizers and rapid application pigments. The make-up contains anti-microbial and antibacterial agents.

The present applicator includes a carrier sheet in any of a variety of sizes, shapes, color combinations and types, and which are sufficiently inexpensive to be disposable.

The general cosmetic indicia applicator used for this system includes a carrier sheet formed of woven or non-woven material, and has a forward face which is impregnated with pigment material to produce at least one color, whether single color and multiple color combinations. Various cosmetic formulas are provided, including organic and non-organic pigment materials, minerals, jells and powders.

2. Description of the Prior Art

There has long been a practice of spraying a sample of a fragrance onto a customer hand or arm for the customer to evaluate and decide whether to buy the particular brand name of fragrance. This can be helpful because, with so many fragrances to choose from, finding the right one can be an overwhelming experience for many customers. The fragrance industry continues to evolve and to produce new fragrance products.

Yet providing sample applications presents a practical problem. Fragrance products are generally a combination of essential oils in a special alcohol base. They are designed in three phases: top, middle and base notes. The first impression, the top note, lasts about ten minutes, and it has a strong initial smell of alcohol. Within about twenty minutes the middle note develops. Then, in about two hours, the base note develops and the resulting final fragrance produced in the base note phase varies from one person to another depending on differences in their body chemistry. Thus the problem with providing sample applications of fragrance products to the skin of customers is that, by the time the base note develops and the final fragrance is known to the customer, they no longer remember what brand the product was. Customers in a store spray a few different fragrance products onto their skin, usually on their arms, one next to the other, and then wait for the base note and finally do not remember the name of the favorite.

It is thus an object of the present invention to provide a press-on fragrance product applicator which simultaneously applies a quantity of the fragrance material and pigment material forming indicia identifying the fragrance brand applied so that later, when the final fragrance is produced, the customer can simply look at the indicia and readily identify which brand of fragrance was applied and decide whether to purchase that brand.

It is another object of the present invention to provide such an applicator which produces such indicia which takes the form of a brand name, a logo, or a color image of a product bottle and its label.

It is finally an object of the present invention to provide such an applicator which is highly inexpensive to manufacture and therefore is disposable after a single use.

### SUMMARY OF THE INVENTION

The present invention accomplishes the above-stated objectives, as well as others, as may be determined by a fair reading and interpretation of the entire specification.

A fragrance applicator is provided, including a quantity of fragrance material; a quantity of transferrable pigment material; a carrier sheet retaining the quantity of fragrance material and having a carrier sheet forward face on which the quantity of transferrable pigment material is retained forming indicia identifying the brand of the fragrance; so that pressing the carrier sheet forward face against human skin leaves a quantity of the fragrance and a quantity of the pigment material forming the indicia on the human skin.

The carrier sheet preferably is formed of one of woven and non-woven material. The pigment material preferably includes several pigment materials producing several colors. The indicia preferably defines at least one of: the shape of a fragrance product bottle, a name of a fragrance product, and an identifying label of a fragrance product. The carrier sheet preferably is formed of inexpensive material to be disposable. The pigment material preferably is rapid application pigment material.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a perspective view of a first embodiment of the present applicator, showing the indicia in the form of an image of a fragrance product bottle on the carrier sheet forward face and the transferred image on the skin of a customer arm.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

### First Preferred Embodiment

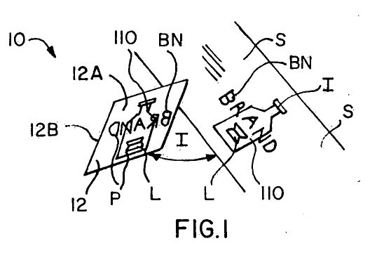

Referring to FIG. 1, a press-on fragrance product applicator 10 is disclosed for applying cosmetic colors to arms or other regions of a customer body which leaves indicia I identifying a product brand and which simultaneously applies fragrance corresponding to the identified brand, so that after sufficient time has passed for the fragrance to mix and react with customer body chemistry and produce a final fragrance, the customer can still identify which brand of fragrance product was applied and thus determine whether he or she wishes to purchase the brand. This applicator 10 applies color directly to bare human skin, whether bare skin or on top of an already colored area of customer skin. The indicia I may be a printed brand name BN only or brand logo L, but more preferably is an image of the brand bottle itself including its identifying label.

Each press-on applicator 10 includes a soft color carrier sheet 12, impregnated with a pre-measured amount of cosmetic indicia pigment material P including rapid application transferrable pigment materials mixed with fragrance P. The term transferrable pigment material is understood to mean pigment material which can be transferred from carrier sheet 12 to a target surface such as human skin through contact with the target surface.

The present applicator 10 includes a carrier sheet 12 having any of a variety of sizes, shapes, color combinations and types, which are sufficiently inexpensive to be disposable. The carrier sheet can be cut into unique shapes.

### General Fragrance Product Applicator

The general cosmetic indicia applicator 10 used for this system includes a carrier sheet 12 formed of woven or non-woven material, and has a sheet forward face 12A which is impregnated with pigment material P for producing color, whether a single color or multiple color combinations mixed with fragrance and has a sheet rearward face 12B.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim as my invention:

1. A fragrance applicator, comprising:
a quantity of transferrable pigment material;
a quantity of fragrance material producing a fragrance;
and a carrier sheet retaining said quantity of fragrance material and having a sheet rearward face and having a sheet forward face on which said quantity of transferrable pigment material is retained forming indicia identifying the brand of the fragrance;
such that pressing said carrier sheet forward face against human skin leaves a quantity of said fragrance and a quantity of said pigment material forming said indicia on the human skin.

2. The fragrance applicator of claim 1, wherein said carrier sheet is formed of one of: woven and non-woven material.

3. The fragrance applicator of claim 1, wherein said pigment material comprises a plurality of pigment materials producing a plurality of colors.

4. The fragrance applicator of claim 1, wherein said pigment material comprises at least one of: a vitamin, a mineral, an organic pigment material, a non-organic pigment material, a moisturizer, a jell, a powder, an anti-microbial agent and an antibacterial agent.

5. The fragrance applicator of claim 1, wherein said indicia defines the shape of a fragrance product container.

6. The fragrance applicator of claim 1, wherein said indicia defines a name of a fragrance product.

7. The fragrance applicator of claim 1, wherein said indicia defines an identifying label of a fragrance product container.

8. The fragrance applicator of claim 1, wherein said carrier sheet is formed of inexpensive material to be disposable.

9. The fragrance applicator of claim 1, wherein said pigment material is rapid application pigment material.
